(19) United States
(12) Patent Application Publication
(10) Pub. No.: US 2015/0325186 A1
(43) Pub. Date: Nov. 12, 2015

(54) LIQUID CRYSTAL DISPLAY PANEL AND DRIVING METHOD THEREOF

(71) Applicant: SHENZHEN CHINA STAR OPTOELECTRONICS TECHNOLOGY CO., LTD., Shenzhen (CN)

(72) Inventors: JinJie WANG, Shenzhen (CN); Cheng-Hung Chen, Shenzhen (CN)

(73) Assignee: SHENZHEN CHINA STAR OPTOELECTRONICS TECHNOLOGY CO., LTD., Shenzhen (CN)

(21) Appl. No.: 14/004,167

(22) PCT Filed: Jun. 27, 2013
(86) PCT No.: PCT/CN2013/078175

§ 371 Date: Sep. 10, 2013

(30) Foreign Application Priority Data
Apr. 3, 2013 (CN) 201310115474.6

(51) Int. Cl. G09G 3/36

(52) U.S. Cl. CPC G09G 3/3614; G09G 2320/0223

(57) ABSTRACT

The present invention provides a liquid crystal display panel and a driving method thereof, in which a gate driving unit makes scan signals input to respective rows of plural scan lines at an interval of a number of rows and a source driving unit makes grey-level voltages input to plural data lines extending along a column direction at an interval of a number of columns. The present invention can solve the problem of pixel chargeability inconsistence, which is caused by voltage drops on the signal lines.

### BACKGROUND OF THE INVENTION

1. Field of the Invention

The present invention relates to a liquid crystal displaying technology, and more particularly, to a liquid crystal display panel and a driving method thereof.

2. Description of Prior Art

As liquid crystal display panels are widely used, the demands for image quality of the liquid crystal display panels are higher and higher.

Please refer to FIG. 1, FIG. 1 is a schematic structural diagram showing a pixel structure of a conventional liquid crystal display panel. The liquid crystal display panel comprises 2m strips of data lines D′1-D′2m, 2k strips of scan lines G′1-G′2k, a gate driving chip 11, and a source driving chip 12. The data lines and the scan lines are intersected with each other, The gate driving chip 11 is connected to the scan lines and the source driving chip 12 is connected to the data lines. A region intersected by two adjacent data lines and two adjacent scan lines forms one pixel unit (not labeled). Each pixel unit has a thin film transistor and a liquid crystal capacitor (not shown) disposed therein. The respective columns of pixel units respectively correspond to R pixel, G pixel, and B pixel.

Grey-level voltages transmitted on the data lines (D′1-D′2m) can be divided into positive grey-level voltages, negative grey-level voltages, and grey-level voltages with 0 value, in which a common voltage Vcom is served as a reference voltage. The positive grey-level voltage indicates that its voltage is higher than the common voltage Vcom, the negative grey-level voltage indicates that its voltage is lower than the common voltage Vcom, and the grey-level voltage with 0 value indicates that its voltage is equal to the common voltage Vcom. In theory, display effects are the same when an identical grey value is represented by the positive grey-level voltage and the negative grey-level voltage, respectively.

In the structure of the liquid crystal display panel shown in FIG. 1, one data line located at the intermediate area (i.e., not at both sides) will be connected to the pixel units at left and right sides thereof at an interval of one row. Utilizing such a structure can implement column inversion and dot inversion.

More specifically, when displaying an image in the R pixel, G pixel, and B pixel, two adjacent columns of pixels are bright and the other one column is dark. Taking an aqua blue image for example, the columns of pixels corresponding to G pixel and B pixel are inputted with grey-level voltages and the column of pixels corresponding to R pixel is inputted with grey-level voltages with 0 value. The inputted signal voltages are referred to FIG. 2. Since the aqua blue image is to be displayed, R pixels are all dark and thus the columns of pixel units corresponding to R pixel are zero in its polarity. The G pixels and B pixels are in the bright state, and the G pixels and B pixels have alternation of signs in its polarity according to a flip-pixel driving method. In such an manner, the screen is thus driven by the dot inversion.

In concrete implementations, the scan lines are scanned row by row, in order. The grey-level voltages are inputted to the thin film transistors by the data lines once the scan signals on the scan lines turn on the thin film transistors of the pixel units. For example, referring to waveforms of signal lines shown in FIG. 3, the data line D′2 corresponds to 0 loop signals, the G pixels and B pixels connected to the data line D′3 all corresponds to positive signals, and the data line D′4 corresponds to negative loop signals. Since the signal lines (including the scan lines and the data lines) themselves exist RC loading, this makes that the chargeability on the far ends of the data line D′2 and the data line D′4 is lower than that on the start ends thereof, thereby making chargeability inconsistence between the pixel units corresponding to the same data line. With respect to the data line D′3, there is no signal delay on the data line D′3 and the pixels corresponding thereto can be charged normally since the signals transmitted thereon are DC signals.

Referring back to FIG. 3, the above-mentioned charging results in chargeability inconsistence between the respective pixel units located in the same column, and thus some pixels appear bright while some appear dark. Therefore, horizontal bright and dark lines appear on the screen at the output ends of the signal lines.

### SUMMARY OF THE INVENTION

An objective of the present invention is to provide a liquid crystal display panel and a driving method thereof, for solving the technical problem of horizontal bright and dark lines appearing on the liquid crystal display panel due to pixel chargeability inconsistence, which is caused by voltage drops on the signal lines in the conventional skills.

To solve above technical problem, the present invention provides a liquid crystal display panel, which comprises a plurality of data lines extending along a column direction and a plurality of scan lines extending along a row direction, the data lines and the scan lines are arranged perpendicular to each other and are intersected with each other, two adjacent data lines and two adjacent scan lines cross each other to form a pixel unit, each pixel unit has a thin film transistor disposed therein;

In which, source electrodes of the thin film transistors of the pixel units arranged in a same row are connected to the data lines located at a same side; with respect to two adjacent rows, source electrodes of the thin film transistors of two adjacent pixel units aligned along the column direction are connected to the data lines located at two sides, respectively; gate electrodes of the thin film transistors in each row of the pixel units all are connected to a scan line in a corresponding row;

The liquid crystal display panel further comprises a gate driving unit and a source driving unit, the gate driving unit is electrically connected to the plural scan lines and makes scan signals input according to a first predetermined order, the gate driving unit makes the scan signals input to the respective rows of the plural scan lines at an interval of a number of rows under the first predetermined order;

The source driving unit is electrically connected to the plural data lines and makes grey-level voltages input according to a second predetermined order, the source driving unit makes the grey-level voltages input to the plural data lines extending along the column direction at an interval of a number of columns under the second predetermined order;

In which, with respect to three sequential adjacent columns of pixel units, two columns are in a bright state and the other one column is in a dark state when the gate driving unit makes the scan signals input according to the first predetermined order and the source driving unit makes the grey-level voltages input according to the second predetermined order.

To solve above technical problem, the present invention further provides a liquid crystal display panel, which comprises a plurality of data lines extending along a column direction and a plurality of scan lines extending along a row direction, the data lines and the scan lines are arranged perpendicular to each other and are intersected with each other, two adjacent data lines and two adjacent scan lines cross each other to form a pixel unit, each pixel unit has a thin film transistor disposed therein;

In which, source electrodes of the thin film transistors of the pixel units arranged in a same row are connected to the data lines located at a same side; with respect to two adjacent rows, source electrodes of the thin film transistors of two adjacent pixel units aligned along the column direction are connected to the data lines located at two sides, respectively;

The liquid crystal display panel further comprises a gate driving unit and a source driving unit, the gate driving unit is electrically connected to the plural scan lines and makes scan signals input according to a first predetermined order, the gate driving unit makes the scan signals input to the respective rows of the plural scan lines at an interval of a number of rows under the first predetermined order;

The source driving unit is electrically connected to the plural data lines and makes grey-level voltages input according to a second predetermined order, the source driving unit makes the grey-level voltages input to the plural data lines extending along the column direction at an interval of a number of columns under the second predetermined order;

To solve above technical problem, the present invention further provides a driving method for a liquid crystal display panel, said method comprising steps of:

A gate driving unit is utilized to make scan signals input according to a first predetermined order, the gate driving unit makes the scan signals input to respective rows of plural scan lines at an interval of a number of rows under the first predetermined order;

A source driving unit is utilized to make grey-level voltages input according to a second predetermined order, the source driving unit makes the grey-level voltages input to plural data lines extending along a column direction at an interval of a number of columns under the second predetermined order.

When driving signal lines in the embodiment of the present invention, the signal lines (e.g., scan lines and data lines) are inputted with signals or grey-level voltages at intervals. The present invention avoids chargeability inconsistence between the respective pixel units, which is caused by voltage drops on the signal lines when two columns of pixel units are in the bright state and the other one column of pixel units is in the dark state with respect to three sequential adjacent columns of pixel units. Accordingly, the present invention solves the problem of horizontal bright and dark lines appearing on the screen, coming from output ends of the signal lines, and thereby improving image display quality of the liquid crystal display panel.

To make above content of the present invention more easily understood, it will be described in details by using preferred embodiments in conjunction with the appending drawings.

### BRIEF DESCRIPTION OF THE DRAWINGS

FIG. 1 is a schematic structural diagram showing a conventional liquid crystal display panel.

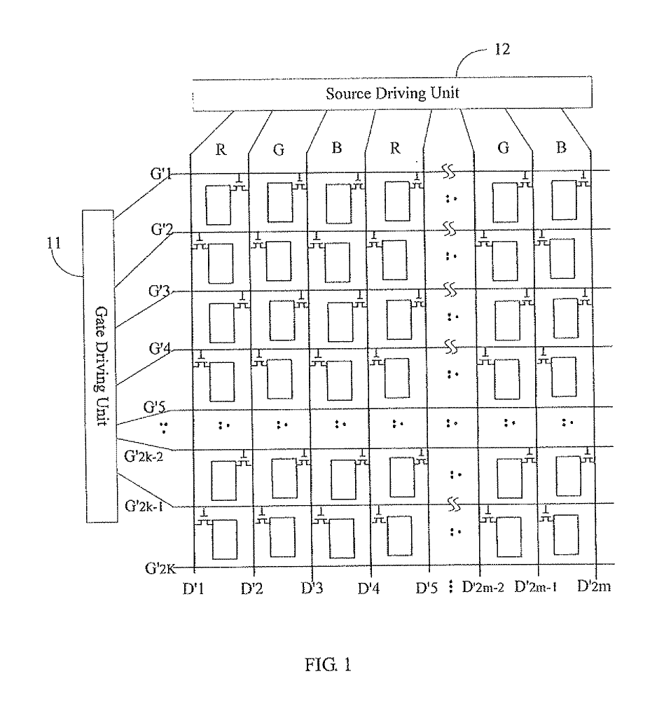

FIG. 2 is a schematic diagram showing voltages of pixel units when driven by utilizing a dot inversion method in a conventional liquid crystal display panel.

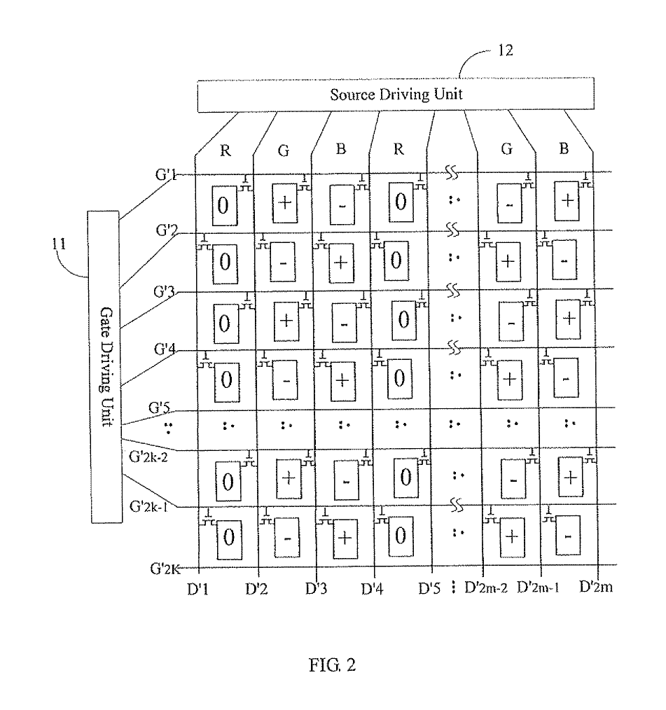

FIG. 3 is a waveform diagram based on a conventional dot inversion driving method.

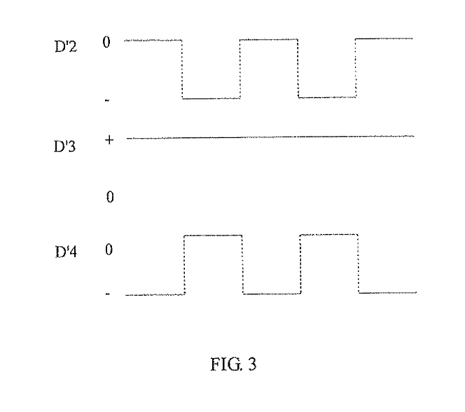

FIG. 4 is a schematic structural diagram showing a liquid crystal display panel according to an embodiment of the present invention.

FIG. 5 is a schematic waveform diagram based on a dot inversion driving method utilized for a liquid crystal display panel according to an embodiment of the present invention.

FIG. 6 is a flow chart of a driving method for a liquid crystal display panel according to an embodiment of the present invention.

### DETAILED DESCRIPTION OF THE PREFERRED EMBODIMENTS

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “inner”, “outer”, “lateral”, and the like, may be used herein for ease of description as illustrated in the figures. Therefore, it will be understood that the spatially relative terms are intended to illustrate for understanding the present invention, but not to limit the present invention. In the appending drawings, units having similar structures are labeled by the same reference numbers.

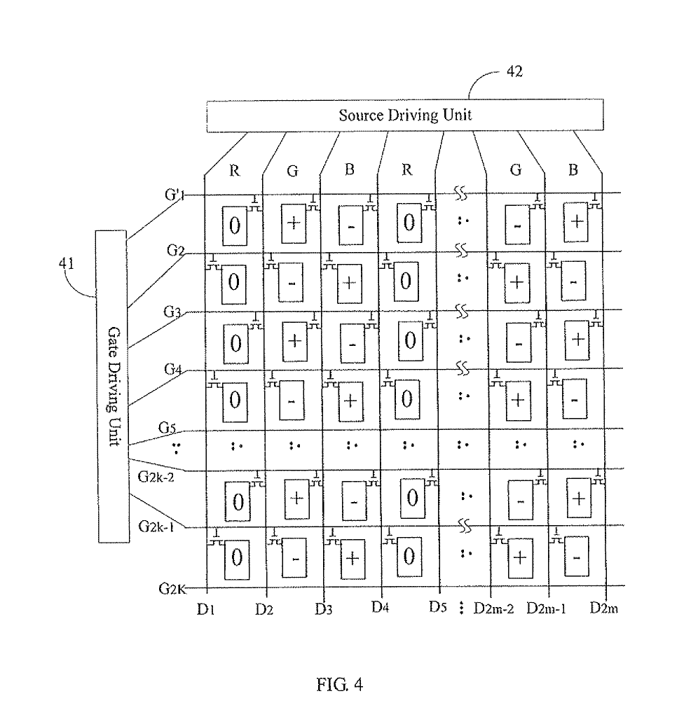

Please refer to FIG. 4. FIG. 4 is a schematic structural diagram showing a liquid crystal display panel according to a preferred embodiment of the present invention.

The liquid crystal display panel comprises a plurality of pixel units, 2m strips of data lines D1-D2m, and 2k strips of scan lines G1-G2k, and further comprises a gate driving unit 41 and a source driving unit 42. The gate driving unit 41 is connected to the scan lines and the source driving unit 42 is connected to the data lines. The data lines and the scan lines are arranged perpendicular to each other and are intersected with each other. As shown in FIG. 4, it is not difficult to see that two adjacent data lines and two adjacent scan lines cross each other to form a pixel unit (not labeled). Each pixel unit has a thin film transistor and a liquid crystal capacitor (not shown) disposed therein. The gate driving unit 41 provides scan signals for the pixel units via the scan lines and the source driving unit 42 provides grey-level voltages for the pixel units via the data lines.

In the embodiment of the present invention, source electrodes of the thin film transistors of the pixel units arranged in a same row are connected to the data lines located at a same side. With respect to two adjacent rows of pixel units, source electrodes of the thin film transistors of two adjacent pixel units aligned along the column direction are connected to the data lines located at two sides, respectively. Gate electrodes of the thin film transistors in each row of the pixel units all are connected to a scan line in a corresponding row. Specifically, referring to FIG. 4, the source electrodes of the thin film transistors of M1-th rows of pixel units are respectively connected to the data lines D2, D3, . . . , the source electrodes of the thin film transistors of M2-th rows of pixel units are respectively connected to the data lines D1, D2, . . . , the source electrodes of the thin film transistors of M3-th rows of pixel units are respectively connected to the data lines D2, D3, . . . , and so on.

In the embodiment of the present invention, the gate driving unit 41 is electrically connected to the plural scan lines and makes scan signals input according to a first predetermined order, wherein the gate driving unit 41 makes the scan signals input to the respective rows of the plural scan lines at an interval of a number of rows under the first predetermined order. The source driving unit 42 is electrically connected to the plural data lines and makes grey-level voltages input according to a second predetermined order, wherein the source driving unit 42 makes the grey-level voltages input to the plural data lines extending along the column direction at an interval of a number of columns under the second predetermined order.

Specifically, the embodiment of the present invention is mainly utilized for the following situations. In columns of pixel units corresponding to adjacent R pixel, G pixel, and B pixel, two columns of pixel units are in bright state and the other one column of pixel units is in dark state for a displayed image. For example, for displaying an aqua blue image, the columns of pixel units corresponding to G pixel and B pixel are in the bright state and meanwhile positive or negative grey-level voltages are required to be inputted, as shown in FIG, 4. The column of pixels units corresponding to R pixel is in the dark state and meanwhile the grey-level voltages with 0 value is required to be inputted. To achieve the above effect, the first predetermined order of the embodiment of the present invention is that in one scanning period, the gate driving unit 41 makes the scan signals input to odd-numbered rows of scan lines and then to even-numbered rows of scan lines. Of course, in concrete implementations, it also can serve two rows of scan lines as one scan unit, and then the gate driving unit 41 makes the scan signals input at an interval of one scan unit, which will not be detailedly described here.

Specifically, the second predetermined order is that in one scanning period, the source driving unit 42 makes the grey-level voltages input to odd-numbered columns of data lines and then to even-numbered columns of data lines. Of course, in concrete implementations, it also can serve two columns of data lines as one data unit, and then the source driving unit 42 makes the grey-level voltages input at an interval of one data unit, which will not be detailedly described here.

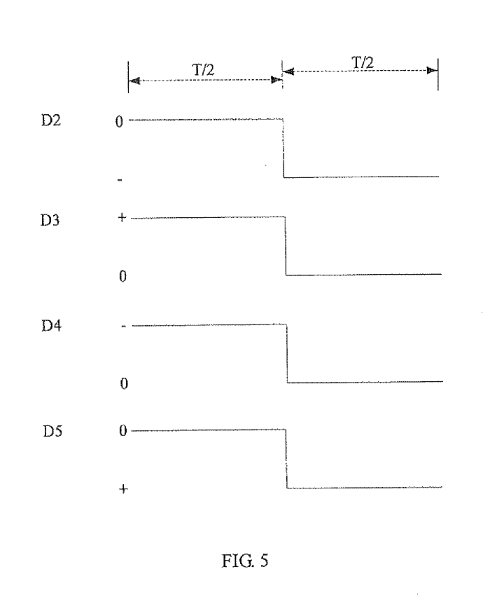

Please refer to FIG. 5. FIG. 5 is a schematic diagram showing voltage waveforms on partial data lines when utilizing a dot inversion driving method on the liquid crystal display panel shown in FIG. 4. The grey-level voltages provided by the data lines comprises positive grey-level voltages (i.e., voltages higher than the common voltage Vcom), negative grey-level voltages (i.e., voltages lower than the common voltage Vcom), and grey-level voltages with 0 value (i.e., voltages equal to the common voltage Vcom).

Taking FIG. 4 and FIG. 5 for example, in order to display the aqua blue image, it needs to make the columns of pixel units corresponding to G pixel and B pixel present as the bright state and make the column of pixel units corresponding to R pixel present as the dark state. The dot inversion driving method of the liquid crystal display panel of the embodiment of the present invention is illustrated as follows.

Firstly, in the first half of period T/2, odd-numbered rows of scan lines G₂ₖ₋₁ are turned on for providing the scan signals and thus the thin film transistors of pixel units located in G₂ₖ₋₁ rows are turned on. Meanwhile, odd-numbered columns of data lines D₂ₖ₋₁ are inputted with the grey-level voltages. For example, the scan lines G1, G3 are turned on and then the data lines D3, D5 are inputted with the grey-level voltages. Meanwhile, the data line D3 provides a positive grey-level voltage to a G pixel unit corresponding thereto and the data line D5 provides a grey-level voltage with 0 value to a R pixel unit corresponding thereto. For example, the pixel unit (G pixel) intersected by the scan line G1 and the data line D3 is written with the positive grey-level voltage, the pixel unit (G pixel) intersected by the scan line G3 and the data line D3 is written with the positive grey-level voltage, and so on.

After that, in the second half of period T/2, even-numbered rows of scan lines G₂ₖ are turned on for providing the scan signals and thus the thin film transistors of pixel units located in G₂ₖ rows are turned on. Meanwhile, even-numbered columns of data lines D₂ₖ are inputted with the grey-level voltages. For example, the scan lines G2, G4 are turned on and then the data lines D2, D4 are inputted with the grey-level voltages. Meanwhile, the data line D2 provides a negative grey-level voltage to a G pixel unit corresponding thereto and the data line D4 provides a grey-level voltage with 0 value to a R pixel unit corresponding thereto. For example, the pixel unit (G pixel) intersected by the scan line G2 and the data line D2 is written with the negative grey-level voltage, the pixel unit (R pixel) intersected by the scan line G4 and the data line D4 is written with the grey-level voltage with 0 value, and so on. By the above driving method, the columns of pixel units corresponding to R pixel are neutral and are all in the dark state. The columns of pixel units corresponding to G pixel and B pixel are positive or negative, have alternation of signs, and are in the bright state. In such a manner, the screen is driven by the dot inversion and is presented with the aqua blue image.

Above all, when the scan signals are inputted to the scan lines in. the embodiment of the present invention, odd-numbered rows of scan signals are inputted first and then the even-numbered rows of scan signals in one scanning period. Meanwhile, odd-numbered columns of data signals are inputted to the data lines first and then the even-numbered columns of data signals. The inputted waveforms are changed in polarity only when switching the odd-numbered rows to the even-numbered rows and are transmitted with DC signals for the rest of time. Accordingly, the present invention can reduce differences appearing in pixel chargeability, which is caused by RC loading, and assure that chargeability for all the pixel units are substantially maintained at an average level, thereby eliminating horizontal bright and dark lines displayed on the liquid crystal display panel.

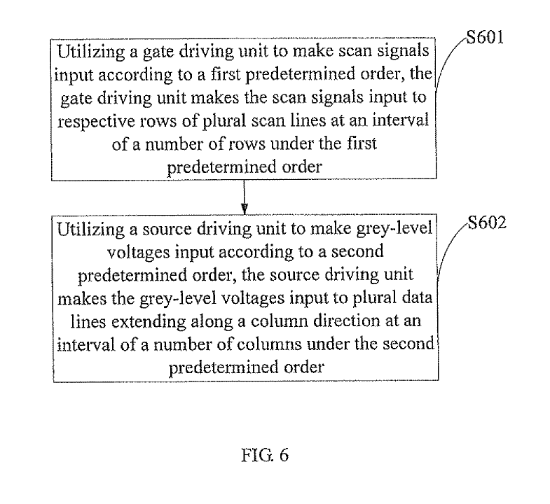

Please refer to FIG. 6. FIG. 6 is a flow chart of a driving method for a liquid crystal display panel provided in the embodiment of the present invention.

In Step S601, the gate driving unit makes scan signals input according to a first predetermined order, wherein the gate driving unit makes the scan signals input to respective rows of plural scan lines at an interval of a number of rows under the first predetermined order.

In Step S602, the source driving unit makes grey-level voltages input according to a second predetermined order, wherein the source driving unit makes the grey-level voltages input to plural data lines extending along the column direction at an interval of a number of columns under the second predetermined order.

Preferably, when the gate driving unit makes the scan signals input according to the first predetermined order and the source driving unit makes the grey-level voltages input according to the second predetermined order, the pixel units of the liquid crystal display panel present the following states. With respect to three sequential adjacent columns of pixel units, two columns are in the bright state and the other one column is in the dark state.

To achieve the above effect, the first predetermined order of the embodiment of the present invention is that in one scanning period, the gate driving unit makes the scan signals input to odd-numbered rows of scan lines and then to even-numbered rows of scan lines. The second predetermined order is that in one scanning period, the source driving unit makes the grey-level voltages input to odd-numbered columns of data lines and then to even-numbered columns of data lines.

Of course, in concrete implementations, the above-described Step S601 and Step S602 are performed simultaneously.

Please refer to FIG. 4 for detailed descriptions of the liquid crystal display panel. The liquid crystal display panel comprises the plural data lines extending along the column direction and the plural scan lines extending along the row direction. The data lines and the scan lines are arranged perpendicular to each other and are intersected with each other. Two adjacent data lines and two adjacent scan lines cross each other to form a pixel unit. Each pixel unit has a thin film transistor disposed therein. Gate electrodes of the thin film transistors in each row of the pixel units all are connected to a scan line in the corresponding row. The pixel units arranged in a same row are connected to the data lines located at the same side. With respect to two adjacent rows, two adjacent pixel units in order are respectively connected to the data lines located at two sides.

When driving signal lines in the embodiment of the present invention, the signal lines (e.g., scan lines and data lines) are inputted with signals or grey-level voltages at intervals. The present invention avoids chargeability inconsistence between the respective pixel units, which is caused by voltage drops on the signal lines when two columns of pixel units are in the bright state and the other one column of pixel units is in the dark state with respect to three sequential adjacent columns of pixel units. Accordingly, the present invention solves the problem of horizontal bright and dark lines appearing on the screen, coming from output ends of the signal lines, and thereby improving image display quality of the liquid crystal display panel.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display panel, which comprises a plurality of data lines extending along a column direction and a plurality of scan lines extending along a row direction, the data lines and the scan lines are arranged perpendicular to each other and are intersected with each other, two adjacent data lines and two adjacent scan lines cross each other to form a pixel unit, each pixel unit has a thin film transistor disposed therein;
wherein source electrodes of the thin film transistors of the pixel units arranged in a same row are connected to the data lines located at a same side; with respect to two adjacent rows, source electrodes of the thin film transistors of two adjacent pixel units aligned along the column direction are connected to the data lines located at two sides, respectively; gate electrodes of the thin film transistors in each raw of the pixel units all are connected to a scan line in a corresponding row;
the liquid crystal display panel further comprises a gate driving unit and a source driving unit, the gate driving unit is electrically connected to the plural scan lines and makes scan signals input according to a first predetermined order, the gate driving unit makes the scan signals input to the respective rows of the plural scan lines at an interval of a number of rows under the first predetermined order;
the source driving unit is electrically connected to the plural data lines and makes grey-level voltages input according to a second predetermined order, the source driving unit makes the grey-level voltages input to the plural data lines extending along the column direction at an interval of a number of columns under the second predetermined order;
wherein with respect to three sequential adjacent columns of pixel units, two columns are in a bright state and the other one column is in a dark state when the gate driving unit makes the scan signals input according to the first predetermined order and the source driving unit makes the grey-level voltages input according to the second predetermined order.

2. The liquid crystal display panel according to claim 1, wherein the first predetermined order is that in one scanning period, the gate driving unit makes the scan signals input to odd-numbered rows of scan lines and then to even-numbered rows of scan lines.

3. The liquid crystal display panel according to claim 1, wherein the second predetermined order is that in one scanning period, the source driving unit makes the grey-level voltages input to odd-numbered columns of data lines and then to even-numbered columns of data lines.

4. A liquid crystal display panel, which comprises a plurality of data lines extending along a column direction and a plurality of scan lines extending along a row direction, the data lines and the scan lines are arranged perpendicular to each other and are intersected with each other, two adjacent data lines and two adjacent scan lines cross each other to form a pixel unit, each pixel unit has a thin film transistor disposed therein;
wherein source electrodes of the thin film transistors of the pixel units arranged in a same row are connected to the data lines located at a same side; with respect to two adjacent rows, source electrodes of the thin film transistors of two adjacent pixel units aligned along the column direction are connected to the data lines located at two sides, respectively;
the liquid crystal display panel further comprises a gate driving unit and a source driving unit, the gate driving unit is electrically connected to the plural scan lines and makes scan signals input according to a first predetermined order, the gate driving unit makes the scan signals input to the respective rows of the plural scan lines at an interval of a number of rows under the first predetermined order;
the source driving unit is electrically connected to the plural data lines and makes grey-level voltages input according to a second predetermined order, the source driving unit makes the grey-level voltages input to the plural data lines extending along the column direction at an interval of a number of columns under the second predetermined order.

5. The liquid crystal display panel according to claim 4, wherein with respect to three sequential adjacent columns of pixel units, two columns are in a bright state and the other one column is in a dark state when the gate driving unit makes the scan signals input according to the first predetermined order and the source driving unit makes the grey-level voltages input according to the second predetermined order.

6. The liquid crystal display panel according to claim 5, wherein the first predetermined Order is that in one scanning period, the gate driving unit makes the scan signals input to odd-numbered rows of scan lines and then to even-numbered rows of scan lines.

7. The liquid crystal display panel according to claim 5, wherein the second predetermined order is that in one scanning period, the source driving unit makes the grey-level voltages input to odd-numbered columns of data lines and then to even-numbered columns of data lines.

8. The liquid crystal display panel according to claim 4, wherein gate electrodes of the thin film transistors in each row of the pixel units all are connected to a scan line in a corresponding row

9. A driving method for a liquid crystal display panel, said method comprising steps of:
utilizing a gate driving unit to make scan signals input according to a first predetermined order, the gate driving unit makes the scan signals input to respective rows of plural scan lines at an interval of a number of rows under the first predetermined order;
utilizing a source driving unit to make grey-level voltages input according to a second predetermined order, the source driving unit makes the grey-level voltages input to plural data lines extending along a column direction at an interval of a number of columns under the second predetermined order.

10. The driving method for the liquid crystal display panel according to claim 9, wherein with respect to three sequential adjacent columns of pixel units, two columns are in a bright state and the other one column is in a dark state when the gate driving unit makes the scan signals input according to the first predetermined order and the source driving unit makes the grey-level voltages input according to the second predetermined order.

11. The driving method for the liquid crystal display panel according to claim 9, wherein the liquid crystal display panel comprises the plural data lines extending along the column direction and the plural scan lines extending along a row direction, the data lines and the scan lines are arranged perpendicular to each other and are intersected with each other, two adjacent data lines and two adjacent scan lines cross each other to form a pixel unit, each pixel unit has a thin film transistor disposed therein;
wherein the pixel units arranged in a same row are connected to the data lines located at a same side; with respect to two adjacent rows, two adjacent pixel units in order are respectively connected to the data lines located at two sides.

12. The driving method for the liquid crystal display panel according to claim 10, wherein the first predetermined order is that in one scanning period, the gate driving unit makes the scan signals input to odd-numbered rows of scan lines and then to even-numbered rows of scan lines.

13. The driving method for the liquid crystal display panel according to claim 10, wherein the second predetermined order is that in one scanning period, the source driving unit makes the grey-level voltages input to odd-numbered columns of data lines and then to even-numbered columns of data lines.
